(19) United States
(12) Patent Application Publication
(10) Pub. No.: US 2008/0027870 A1
(43) Pub. Date: Jan. 31, 2008

(54) Method and apparatus for managing license

(75) Inventors: Su-hyun Nam, Seocho-gu (KR); Sang-su Choi, Bucheon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/655,091

(22) Filed: Jan. 19, 2007

(30) Foreign Application Priority Data
Jul. 28, 2006 (KR) 10-2006-0071582

(51) Int. Cl. H04L 9/00

(52) U.S. Cl. 705/59

(57) ABSTRACT

A method and apparatus for effectively managing a plurality of licenses are provided. The method includes selecting a value, which corresponds to license information, from a Hash mapping table; selecting a node corresponding to the license information from a tree structure corresponding to the value; and searching for a license by using license location information contained in the node. The apparatus includes a Hash function processor which computes a first value corresponding to the license information using a Hash function; a controller which selects a tree structure corresponding to the license information based on the first value computed by the Hash function processor; a tree structure manager which selects a node corresponding to the license information from the tree structure; and a storage unit which stores the license.

### CROSS-REFERENCE TO RELATED PATENT APPLICATIONS

This application claims priority from Korean Patent Application No. 10-2006-0071582, filed on Jul. 28, 2006, in the Korean Intellectual Property Office, the disclosure of which is incorporated herein in its entirety by reference.

### BACKGROUND OF THE INVENTION

1. Field of the Invention

Apparatuses and methods consistent with the present invention relate to a method and apparatus for managing a license in order to protect copyright of digital content.

2. Description of the Related Art

The development of storage device technology enables storage devices having a large capacity of several tens of giga-bytes (e.g., hard discs, flash memories, optical storage devices, etc.) to be attached to home network devices, and particularly to, mobile devices. This trend has resulted in an increase in the total amount of content stored in each device.

Also, various techniques have been developed to protect digital content copyright because of the peculiar characteristics of digital content. A representative technique of protecting content copyright is referred to as digital rights management (DRM). DRM is considered as an assembly of many techniques of protecting content copyright. Typical examples of DRM are MS-DRM provided by Microsoft, and Fair-play provided by Apple's i-Pod.

In general, DRM is comprised of encrypted content, information for decrypting the encrypted content, and a license that contains information for controlling use of the content. Each DRM technique is required to provide functions of controlling use of content by using a license thereof, and decrypting encrypted content.

The more content to be stored in a device, the more licenses there are to be stored in the device. Accordingly, a data management structure is needed in order to quickly search a device for a license, and to add a license to or delete a license from the device while using a small amount of resources.

One of the methods of searching for and managing data is to use a Hashing algorithm that searches for and manages data by using a Hash value given to the data, such as the identification (ID) of the data. The Hashing algorithm, which consists of a Hash function and a Hash mapping table, provides a method of searching for desired data by comparing the result of performing the Hash function on a specific Hash value with Hash mapping table.

The Hashing algorithm has an advantage of having ideal time complexity/performance of O(1). That is, the Hashing algorithm allows desired data to be searched for by performing an operation only once. However, the Hashing algorithm has a problem in that N spaces are needed to make a table for N entities while maintaining time complexity/performance of O(1). That is, as the number of entities is increased, the number of index spaces required is increased so as to be proportional to the number of entities. To address this problem, the related art technique is to use a Hashing mapping table having a limited size. Only M spaces are used to make a table of N entities (N>M).

Since the size of the mapping table is limited, data indexes to be stored are likely to collide against one another. That is, even though the total amount of data approaches infinity, the number of values obtained by performing the Hash function or the number of values of the mapping table remains a finite value N. In the worst-case scenario, all the data may be mapped to one index. This phenomenon is influenced by the Hash function, and there have been developed different types of Hashing algorithms, such as a dynamic Hashing algorithm and a multi-level Hashing algorithm.

As another method of searching for and managing data, a Binary Tree (B-Tree) structure is widely used. A tree structure, which is a data structure that maintains a balanced structure for a given key, provides modes of data addition, data deletion, and data search, and guarantees fast performance in each mode. Such tree structure always maintains a balanced structure and can be easily modified according to the number of other nodes managed by each node.

The B-tree structure has disadvantages, however, in that a large amount of time may be required for comparison when the length of each key for data search is significantly long, and all the data must have different, unique keys. Thus, data can be managed only after a whole tree structure is formed, and the more nodes there are, the more resources are used. For example, when 50,000 pieces of music are stored, 50,000 nodes must be allocated to form a whole group of tree structures. Also, unlike the Hashing algorithm, the B-tree structure requires the time of O(log N) to search for a piece of data, which means that an operation must be performed log N times in order to search for desired data.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above. Exemplary embodiments of the present invention provide a method of effectively managing data, as the capacity of storage devices has increased and the total number of content or licenses to be stored has accordingly increased rapidly.

According to an aspect of the present invention, there is provided a method of searching for a license, the method comprising selecting a value, which corresponds to license information, from a Hash mapping table; selecting a node corresponding to the license information from a tree structure corresponding to the value; and searching for a license by using license location information contained in the node.

The license information may be related to content that is to be controlled by the license.

The, license information may be identification of the license.

### BRIEF DESCRIPTION OF THE DRAWINGS

The above and other aspects of the present invention will become more apparent by describing in detail exemplary embodiments thereof with reference to the attached drawings in which:

FIG. 1 is a conceptual diagram of license management according to an exemplary embodiment of the present invention;

FIG. 2 is a block diagram of an apparatus for managing a license according to an exemplary embodiment of the present invention;

FIG. 3 is a flowchart illustrating a method of managing a license according to an exemplary embodiment of the present invention; and

FIG. 4 is a flowchart illustrating a method of managing a license according to another exemplary embodiment of the present invention.

### DETAILED DESCRIPTION OF EXEMPLARY EMBODIMENTS OF THE INVENTION

Hereinafter, exemplary embodiments of the present invention will be described in detail with reference to the accompanying drawings. Like reference numerals denote like elements throughout the drawings.

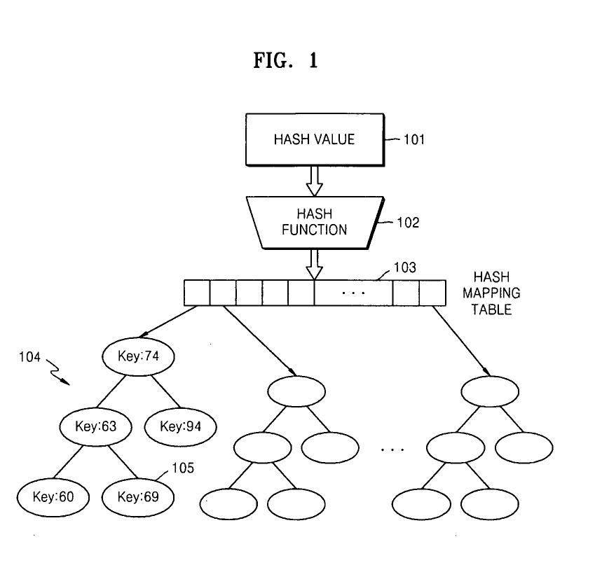

FIG. 1 is a conceptual diagram of license management according to an exemplary embodiment of the present invention. License management includes three basic modes, which are a license addition mode, a license deletion mode, and a license search mode. The most basic mode is a search mode in which a first value corresponding to input license information is computed by performing a Hash function 102 using the license information as a Hash value 101 and a second value corresponding to the first value is selected from the Hash mapping table 103. Then, a tree structure 104 associated with the second value selected from the Hash mapping table 103 is selected, and a node corresponding to the license information is searched for using the license information as a key of the tree structure 104.

In general, the license information is information, such as the identification/identifier (ID) of a license file. When a user inputs to a device a request to execute content or perform an operation, the device first must interpret a license of the requested content.

It is possible to determine whether the user has a right to use the content, and extract information, such as key information for decrypting encrypted content, by interpreting the content license. The extracted information allows use of the content to be controlled according to the user's request. In order to execute the content, content license is first searched for and accessed. In order to achieve this, a device storing the license manages the license in the form of a database. In most related art methods, a license is managed by using a binary tree structure.

However, as use of large-capacity storage devices has become popular and the number of files or content to be stored and managed increases rapidly, the number of licenses to be managed accordingly also increases rapidly. For example, if 50,000 pieces of music content and licenses thereof are managed by using a binary tree structure, a node of a binary tree structure stores the location information of a license, that is, a node corresponds to only one license, when all of the licenses are constructed in the form of a group of binary tree structures. Assuming that a piece of pointer pointing to a corresponding license is 4 bytes long, apart from the license information, a storage space of 200 KB (50,000×4 bytes) is needed. Accordingly, a major part of the memory of a device must be allocated for the group of tree structures.

However, if a Hashing technique is used together with the binary tree structure, it is possible to reduce memory usage and increase the speed of computation. For example, as illustrated in FIG. 1, a license having an ID of 69 is searched for by computing a first value by performing the Hash function 102 with the ID 69 as a Hash value 101, selecting a second value corresponding to the first value from the Hash mapping table and selecting a tree structure associated with the second value. If a tree structure corresponding to the license ID is determined, a node associated with the second value is searched by using the License ID as the key of the tree structure. For example, as illustrated in FIG. 1, if the tree structure corresponding to license ID 69 is determined, 69 is compared with 74 at the first node of 74. Since 69 is smaller than 74, 69 is compared with 63 at a left node of 63. Then, because 69 is greater than 63 the node 105 is determined corresponding to the license. When a corresponding node is determined, it is possible to access the license, based on the location information the corresponding node contains.

As, described above, when the Hashing algorithm is used together with the tree structure, if 50,000 licenses are stored, the size of memory to be allocated is 50,000/100×4+100×4=2.4 KB in order to search for a license, assuming that a Hashing table is about 100 bytes long. When the Hashing algorithm is used together with the binary tree structure, only a tree structure associated with the second value is loaded into memory instead of the whole group of tree structures. In this case, the memory size used is 100 times smaller than when only a tree structure is used.

As described above, the amount of search time incurred is O(log N) when only a tree structure is used. On the other hand, when the Hashing algorithm is used together with the tree structure, if 50,000 licenses are stored, ideally, 500 (50,000/100) nodes are allocated to a tree structure, thereby requiring a total amount of search time is O(1)+O(log n), where n is 500. In general, since a tree structure is a balanced structure, even if random data is input by hashing, it is possible to always maintain stable depth. In an exemplary embodiment of the present invention, the ID of a license is used as license information, but any information allowing the license to be identified the license may be available as license information.

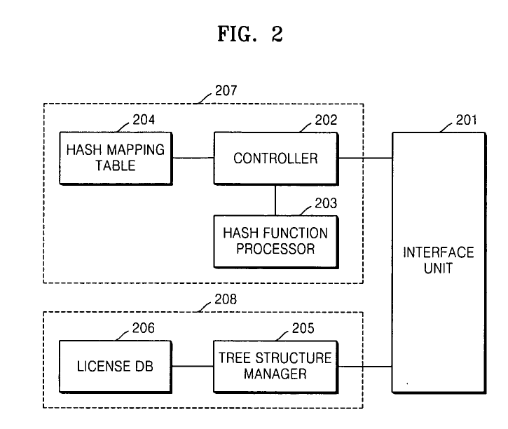

FIG. 2 is a block diagram of an apparatus for managing a license according to an exemplary embodiment of the present invention. The apparatus comprises a license detection unit 207, a license storage unit 208, and an interface unit 201. The license detection unit 207 comprises a controller 202, Hash function processor 203, and a Hash mapping table 204. The license storage unit 208 comprises a tree structure manager 205 and a license database (DB) 206. When a user requests content to be executed, a license corresponding to the content is requested and searched for in order to access the license. In this case, it is advantageous to use an interface unit 201 to deliver such information as the location information of the license, etc.

The apparatus of FIG. 2 for detecting the location of a license from license information may be embodied within a central processing unit (CPU) of a system. When license information is input to the apparatus, a Hash function processor 203 computes a first value by performing a Hash function with the input license information as a Hash value. Then, a controller 202 searches a Hash mapping table 204 for a second value corresponding to the first value, and selects a tree structure corresponding to the second value. When the tree structure is selected, a tree structure manager 205 selects a corresponding node by using the license information as a key of the tree structure. A license corresponding to the license information is obtained from a license database (DB) 206 by using the location information contained in the corresponding node.

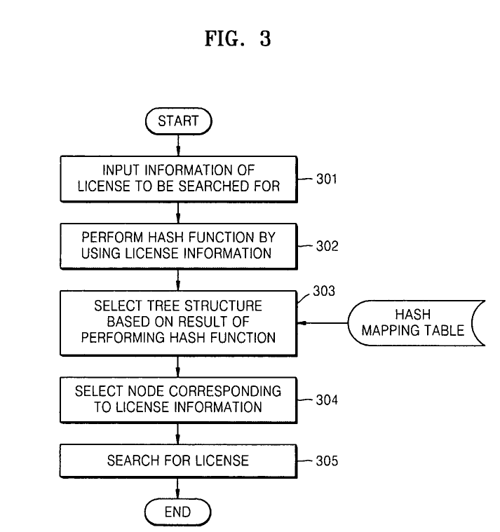

FIG. 3 is a flowchart illustrating a method of searching for a license according to an exemplary embodiment of the present invention. When information of a license that is to be searched for is input (Operation 301), a Hash function is performed using the license information to compute a first value (Operation 302). A second value mapped to the first value is selected from the Hash mapping table, and a tree structure associated with the second value is selected (Operation 303). A node corresponding to the license information is selected from the tree structure by using the license information as a key of the tree structure (Operation 304), and a license corresponding to the license information is searched for by using the location information contained in the node (Operation 305).

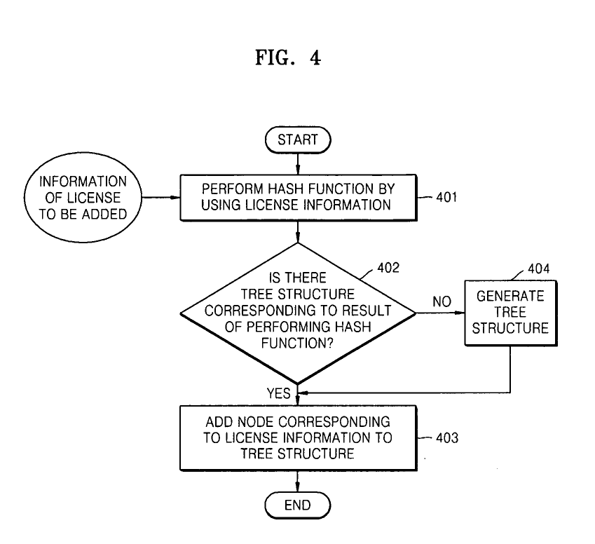

FIG. 4 is a flowchart illustrating a method of adding a license according to another exemplary embodiment of the present invention. First, a Hash function is performed using the information of license that is to be added (Operation 401), and then, it is determined whether a tree structure corresponding to the result of performing the Hash function is present (Operation 402). If it is determined that a corresponding tree structure is present, a node corresponding to the license information is added to the tree structure corresponding to the license information (Operation 403). If it is determined that a corresponding tree structure is not present, a tree structure corresponding to the result of performing the Hash function is newly generated (Operation 404), and a node corresponding to the license information is added to the newly generated tree structure (Operation 403).

A process of deleting a license may be performed in a similar way in which the process of searching a license is performed. That is, a node corresponding to the information of license that is to be deleted is searched for according to the method of FIG. 3, and the searched node is then deleted.

The present inventive concept can be embodied as computer readable code in a computer readable medium. The computer readable medium may be any recording apparatus capable of storing data that is read by a computer system, e.g., a read-only memory (ROM), a random access memory (RAM), a compact disc (CD)-ROM, a magnetic tape, a floppy disk, an optical data storage device, and so on. Also, the computer readable medium may be a carrier wave that transmits data via the Internet, for example. The computer readable medium can be distributed among computer systems that are interconnected through a network, and the present invention may be stored and implemented as computer readable code in a distributed system.

According to a method and apparatus for managing a license, it is possible to effectively use limited resources of a device, and quickly search for, add, or delete a license while minimizing memory usage.

While this inventive concept has been particularly shown and described with reference to exemplary embodiments thereof, it will be understood by those of ordinary skill in the art that various changes in form and details may be made therein without departing from the spirit and scope of the invention as defined by the appended claims.

What is claimed is:

1. A method of searching for a license, the method comprising:
selecting a value, which corresponds to license information, from a Hash mapping table;
selecting a node corresponding to the license information from a tree structure corresponding to the value; and
searching for a license by using license location information contained in the node.

2. The method of claim 1, wherein the license information is related to content that is to be controlled by the license.

3. The method of claim 1, wherein the license information is an identification of the license.

4. The method of claim 1, wherein selecting the value comprises:
computing a first value by performing a Hash function with a license identifier as a Hash value; and
selecting a second value corresponding to the first value from Hash mapping table.

5. The method of claim 1, wherein selecting the node comprises selecting the node using the license information as a key of the tree structure.

6. A method of adding a license, the method comprising:
selecting a value, which corresponds to license information, from a Hash mapping table;
determining a presence of a node corresponding to the license information in a tree structure corresponding to the value; and
adding the node to the tree structure

7. The method of claim 6, wherein, if a tree structure corresponding to the license is not present, a tree structure corresponding to the license information is newly generated, and a node corresponding to the license information is added to the newly generated tree structure.

8. An apparatus for managing a license, the apparatus comprising:
a Hash function processor which computes a first value corresponding to the license information using a Hash function;
a controller which selects a tree structure corresponding to the license information based on the first value computed by the Hash function processor;
a tree structure manager which selects a node corresponding to the license information from the tree structure; and
a storage unit which stores the license.

9. The apparatus of claim 8, further comprising Hash mapping table storage unit storing a Hash mapping table which contains information for mapping the first value into a second value used to select a tree structure corresponding to the license information.

10. The apparatus of claim 8, wherein the license information is an identification of the license.

11. A method of reproducing content, the method comprising:
extracting license information corresponding to the content from the content;
selecting a tree structure by applying a Hash function to the license information;
searching the tree structure for license location information;
obtaining the license using the license location information; and
controlling reproduction of the content by using the license.

12. The method of claim 11, wherein selecting the tree structure comprises:
computing a first value by applying a Hash function to the license information; and
selecting a tree structure corresponding to the first value from a Hash mapping table.

13. The method of claim 11, wherein searching the tree structure for the license location information comprises selecting a corresponding node in the tree structure by using the license information as a key value of the tree structure.
